(19) United States
(12) Patent Application Publication
(10) Pub. No.: US 2025/0330372 A1
(43) Pub. Date: Oct. 23, 2025

(54) METHOD AND SYSTEM FOR REPLACING PIN ELEMENT WITH GATEWAY CAPABILITY IN PERSONAL IOT NETWORK

(71) Applicant: Samsung Electronics Co., Ltd., Suwon-si, Gyeonggi-do (KR)

(72) Inventor: Arunprasath RAMAMOORTHY, Bangalore (IN)

(21) Appl. No.: 18/870,187

(22) PCT Filed: May 31, 2023
(86) PCT No.: PCT/KR2023/007426

§ 371 Date: Nov. 27, 2024

(30) Foreign Application Priority Data
Jun. 1, 2022 (IN) 202241031515
May 16, 2023 (IN) 2022 41031515

(51) Int. Cl. H04L 41/0668; H04L 43/0805; H04W 60/04

(52) U.S. Cl. CPC H04L 41/0668; H04L 43/0805; H04W 60/04

(57) ABSTRACT

The disclosure relates to a 5G or 6G communication system for supporting a higher data transmission rate. Disclosed is a method and system for replacing a PIN Element with Gateway Capability (PEGC) in a Personal IoT Network (PIN) by a communication device. The method includes detecting whether there is a requirement for the PEGC switchover or replacement from a current PEGC to a new PEGC in case of an occurrence of one or more fault events. The method further includes determining the new PEGC that is capable of performing role of the PEGC for serving as a gateway node. The method includes transmitting a request signal to the determined new PEGC and thereby receiving a response signal. In case that the receiving response signal indicates an acceptance, the method includes sending a notification message to each of the PIN Elements and a PIN Management Server (PIN MS) indicating that role of the current PEGC is being assigned to the new PEGC.

### TECHNICAL FIELD

The present invention generally relates to the field of internet-of-things (IoT) devices and services in 5G networks and beyond networks, and more particularly relates to a system and method for replacing or switchover of a Personal IoT Network (PIN) Element with Gateway Capability (PEGC) in a Personal IoT Network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Personal IoT network (PIN) may be used to enhance 5G Service (5GS) support of PIN, including when the PIN is connected to 5G Core (5GC), either using indirect network communications or other macro network communications. The PIN consists of a plurality of PIN Elements (PINEs) that communicate using one of PIN direct connection or direct network connection and is managed locally. The plurality of PIN Elements is managed by a PIN Element with Management Capability (PEMC). The PEMC is an internal component of the PIN. A PIN Element with Gateway Capability (PEGC) is a PIN Element for establishing connectivity with the 5G network for other PIN Elements. The PEGC may also act as a relay for the communication between PIN Elements of the PIN.

A PIN Element may be authorized to act as the PEGC for a certain duration after which the PEGC may be either removed from the PIN or de-authorized to act as the PEGC. The PEGC might go down for several reasons, such as hardware failure, crash or power drain, duration of its role as PEGC expired, etc., during the time duration of acting as the PEGC. Further, once the PEGC is down, a new PIN Element need to be assigned to take over the role of PEGC when the current PIN Element acting as the PEGC needs to be relinquished from the PEGC role for several reasons as stated above herein. The 3GPP specification TR 23.700-78 V0.3.0 covers the procedure for PEGC replacement triggered by the PIN Element which is currently in charge of the PEGC role. However, in some scenarios like power drain or crash, the PIN Elements acting as the PEGC may not be in a position to send a request to a PIN server to assign another PIN Element to take over the role of the current PEGC. However, in scenarios like power drain or crash of the PIN Elements acting as the PEGC, the existing PEGC replacement methods are inefficient and lack in several ways. For example, the existing PEGC replacement methods do not take into account what sorts of information is required for a new PIN Element for taking over the role of the current PEGC and how to identify the needs for the PEGC replacement. Further, there is no PEGC replacement method that describes a process of handling the PEGC replacement in-ternally within the PIN.

Therefore, there lies a need for one or more solutions for addressing the afore-mentioned problem as discussed above herein regarding the existing PEGC replacement methods.

### DISCLOSURE OF INVENTION

### Technical Problem

The present invention has been made to address at least the above problems and/or disadvantages and to provide at least the advantages described below. Accordingly, an aspect of the present invention provides a method and system for replacing PIN element with gateway capability in personal IoT network.

### Solution to Problem

According to an embodiment, the present disclosure describes a method for replacing or switchover the PEGC in the PIN by a communication device. The communication device corresponds to a PIN Element with Management Capability (PEMC). The method includes detecting whether there is a requirement for the PEGC switchover or replacement from a current PEGC to a new PEGC in case of an occurrence of one or more fault events in the current PEGC. The current PEGC corresponds to a first PIN Element among a plurality of PIN Elements in the PIN, and the current PEGC is serving as a gateway node of the PIN. The method further includes determining the new PEGC that is capable of performing role of the PEGC for serving as the gateway node among the plurality of PIN Elements based on the information available in PIN profile and PIN dynamic information. Furthermore, the method includes transmitting a request signal to the determined new PEGC for acting as the PEGC and serving as the gateway node among the plurality of PIN Elements. Subsequently, the method includes receiving a response signal from the new PEGC in response to the transmitted request signal. If the receiving response signal indicates an acceptance of the request signal by the new PEGC to serve as the serving gateway node, the method includes sending a notification message to each of the PIN Elements and a PIN Management Server (PIN MS). The notification message indicates that the role of the current PEGC is being assigned to the new PEGC and the current PEGC is being released from the role of PEGC.

According to another embodiment, also disclosed herein is a communication system comprising a PIN MS, a PIN including a plurality of PIN Elements, and a PEMC that includes at least one processor and memory. A first PIN element among the plurality of PIN elements may be acting as a current PEGC and serving as a gateway node among the plurality of PIN elements. The at least one processor is configured to detect whether there is a requirement for a PEGC switchover or replacement from the current PEGC to a new PEGC based on an occurrence of one or more fault events. The at least one processor is configured to determine that the new PEGC that is capable of performing role of the PEGC for serving as the gateway node among the plurality of PIN elements based on the information available in PIN profile and PIN dynamic information. Upon determining the capacity of the new PEGC, the processor is configured to transmit a request signal to the determined new PEGC for acting as the PEGC and serving as the gateway node among the plurality of PIN elements. The processor is further configured to receive a response signal from the new PEGC in response to the transmitted request signal. If the received response signal indicates an acceptance of the request signal by the new PEGC to serve as the serving gateway node, the processor is configured to send a notification message to each of the PIN elements and the PIN MS indicating that role of the current PEGC is being assigned to the new PEGC and the current PEGC is being released from the role of PEGC.

According to another embodiment, the present disclosure illustrates a method of replacing or switchover the current PEGC by a communication device, where the communication device corresponds to the PIN MS. The method includes identifying that the current PEGC is down or crashed or a duration of serving as the gateway node is going to end in some time. The method further includes determining a new PEGC based on the information available in the PIN profile and the PIN dynamic information. Furthermore, the method includes transmitting a request signal to the determined new PEGC for acting as the PEGC and serving as the gateway node among the plurality of PIN Elements. If the new PEGC accepts to take up the role of PEGC, the new PEGC transmits success response to the PIN MS. Once the switchover or replacing process is successful, the new PEGC signals all the PINEs which were being served by the current PEGC in the PIN including the PEMC about the change in the PIN Element acting as PEGC and reachability information of the new PEGC.

According to yet another embodiment, the present disclosure illustrates a method of replacing or switchover the current PEGC by a communication device, where the communication device corresponds to the PIN MS. The method includes identifying that the current PEGC is down or crashed. Thereby, the method further includes determining a new PEGC based on the information available in the PIN profile and the PIN dynamic information. The method includes transmitting a request message to the determined PEGC for acting as the PEGC. If the new PEGC accepts to take up the role of PEGC, the new PEGC transmits success response to the PIN MS. Once the switchover or replacement process is successful, the PIN MS transmits signals to all the PINEs which were being earlier served by the current PEGC in the PIN including the PEMC about the change in the PIN Element acting as PEGC and reachability information of the new PEGC. However, if the PIN MS is unable to send the signal to one or more PIN Elements that are not reachable directly from the PIN MS, then the PIN MS transmits signals to the one or more PIN Elements via the PEGC. The PEGC routes the notification signal to the PIN Elements inside the PIN.

According to yet another embodiment, the present disclosure illustrates a method of replacing or switchover the current PEGC by a communication device, where the communication device corresponds to the PIN MS. Once the method includes identifying unavailability of the current PEGC, then the method determines a new PEGC for switchover or replacing the current PEGC by the new PEGC. If the new PEGC accepts to take up the role of PEGC, the new PEGC transmits success response to the PIN MS. Once the switchover or replacement process is successful, the PIN MS transmits signals to the PEMC about the change in the PIN Element acting as PEGC and reachability information of the new PEGC. The PEMC on receiving the signal about the change in PEGC transmits signals to all other PINEs that were being served earlier by a PEGC-1 (i.e., current PEGC) about this change and the new PEGC's reachability information.

According to an embodiment, the present disclosure discloses the method for replacing or switchover of the current PEGC. The PEMC, the current PEGC, the new PEGC, the one or more PINEs are part of the same PIN. The current PEGC is currently serving as the gateway node of the PIN. The PIN MS identifies whether the current PEGC is down/crashed or the duration for servicing as PEGC is expiring soon. On identifying that the current PEGC is down, the PIN MS looks for the PIN profile and PIN dynamic information to identify the new PINE which can take up the role of PEGC (here the new PEGC PIN Element). The PIN MS transmits signals that PINE (i.e., the new PEGC) is to take over the role of PEGC by providing the necessary details about the PIN i.e., PIN dynamic information. In another embodiment, the PINE can fetch the PIN dynamic information from PIN MS on receiving the signal. Further, in case, if the new PEGC element transmits a rejection request, then the PIN MS needs to look for another PINE which can take up the role of PEGC. If the new PEGC PIN Element decides to take up the role of PEGC, the new PEGC transmits the success signal response to the PIN MS.

According to another embodiment of the present disclosure, once the takeover/switchover process is a success, the PIN MS signals all the PINEs (PINEs that were being served by the PEGC-1 earlier) in the PIN including the PEMC about the change in the PIN Element acting as PEGC and reachability information of the new PEGC. The signal to the other PIN Elements which are not reachable directly from the PIN MS is sent via the PEGC. The PEGC routes the notification signal to the PIN Elements inside the PIN. Further, if in a case a PEGC-2 (i.e., the new PEGC) element rejects the request, then PIN MS needs to look for another PINE which can take up the role of PEGC.

According to yet another embodiment of the present disclosure, once the takeover/switchover process is a success, the PIN MS signals the PEMC about the change in the PIN Element acting as the PEGC and reachability information of the new PEGC. Thereafter, the PEMC on receiving the signal about the change in the PEGC notifies all other PINEs (PINEs that were being served by the PEGC-1 earlier) about this change and the new PEGC's reachability information. The PEMC has a list of PIN Elements that are in an active state and connected to the PIN. According to another embodiment, the PEGC may also fetch the PIN dynamic information containing the details of the PIN Elements from the PIN MS or the PEMC.

To further clarify the advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### Advantageous Effects of Invention

Advantages, and salient features of the invention will become apparent to those skilled in the art from the following detailed description, which, taken in conjunction with the annexed drawings, discloses exemplary embodiments of the invention. For more enhanced communication system, there is a need for a method and system for replacing PIN element with gateway capability in personal IoT network.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 illustrates a schematic diagram of a communication system including a PIN, in accordance with an embodiment of the present disclosure;

FIG. 2 illustrates a flow chart of a first method for managing a PIN Element with Gateway Capability (PEGC) switchover or replacement in context with PIN Elements of the PIN, in accordance with an embodiment of the present disclosure;

FIG. 3 illustrates a line diagram of the first method for the PEGC switchover or the PEGC replacement in context with PIN Elements of the PIN, in accordance with an embodiment of the present disclosure;

FIG. 4 illustrates a line diagram of a second method for the PEGC switchover or the PEGC replacement in context with PIN Elements of the PIN, in accordance with an embodiment of the present disclosure;

FIG. 5 illustrates a line diagram of a third method for the PEGC switchover or the PEGC replacement in context with PIN Elements of the PIN, in accordance with an embodiment of the present disclosure;

FIG. 6 illustrates a line diagram of a fourth method for the PEGC switchover or the PEGC replacement in context with PIN Elements of the PIN, in accordance with an embodiment of the present disclosure;

FIG. 7 illustrates a line diagram of a fifth method for the PEGC switchover or the PEGC replacement in context with PIN Elements of the PIN, in accordance with an embodiment of the present disclosure;

FIG. 8 illustrates a line diagram of a sixth method for the PEGC switchover or the PEGC replacement in context with PIN Elements of the PIN, in accordance with an embodiment of the present disclosure;

FIG. 9 illustrates a line diagram of a seventh method for the PEGC switchover or the PEGC replacement in context with PIN Elements of the PIN, in accordance with an embodiment of the present disclosure;

FIG. 10 illustrates a line diagram of an eighth method for the PEGC switchover or the PEGC replacement in context with PIN Elements of the PIN, in accordance with an embodiment of the present disclosure; and

FIG. 11 illustrates a line diagram of a ninth method for the PEGC switchover or the PEGC replacement in context with PIN Elements of the PIN, in accordance with an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been rep-resented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### MODE FOR THE INVENTION

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

Embodiments of the present invention will be described below in detail with reference to the accompanying drawings.

The term Proximity Services (ProSe) used in the present description corresponds to a Device-to-Device (D2D) technology that allows LTE devices to detect each other and to communicate directly.

The terms “Personal IoT Network”, and “PIN” may be used interchangeably throughout the description without deviating from the scope of the present disclosure.

The terms “Personal IoT Network Element”, “PIN Element”, and “PINE” may be used interchangeably throughout the description without deviating from the scope of the present disclosure.

The terms “PIN Element with Management Capability”, and “PEMC” may be used interchangeably throughout the description without deviating from the scope of the present disclosure.

The terms “PIN Element with Gateway Capability”, and “PEGC” may be used interchangeably throughout the description without deviating from the scope of the present disclosure.

The terms “Proximity Services”, and “ProSe” may be used interchangeably throughout the description without deviating from the scope of the present disclosure.

The terms “PIN Management Server”, “PIN MS”, and “PIN Server” may be used interchangeably throughout the description without deviating from the scope of the present disclosure.

The terms “User Equipment”, and “UE” may be used interchangeably throughout the description without deviating from the scope of the present disclosure.

The terms “communication system”, and “system” may be used interchangeably throughout the description without deviating from the scope of the present disclosure.

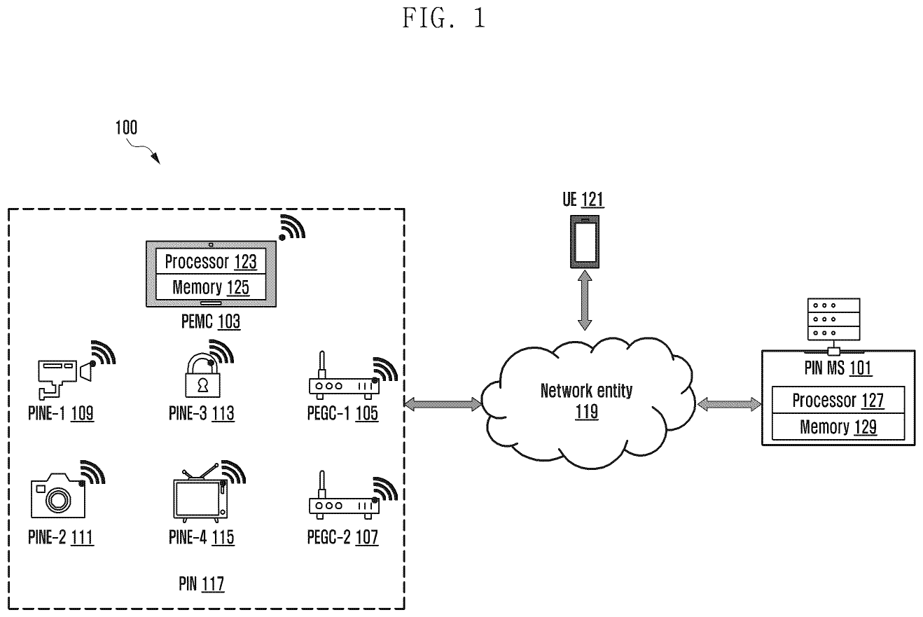

FIG. 1 illustrates a schematic diagram of a communication system including a PIN, in accordance with an embodiment of the present disclosure. The communication system 100 includes a PIN 117, a network entity 119, a PIN MS 101, and a UE 121. The PIN 117 further includes a PEMC 103, a PINE-1 109, a PINE-2 111, a PINE-3 113, a PINE-4 115, a PEGC-1 105, and a PEGC-2 107.

According to an embodiment, the PIN 117 or Personal IoT Network 117 corresponds to a set of connected devices primarily controlled by a user for personal or domestic purposes. An Internet of Things (IoT) is a system of interrelated computing devices, objects, and mechanical machines with digital enablement, etc. More specifically, the IoT system includes smartphones, tablets, smart home devices, wearables, and other gadgets that are designed to make users' lives easier and more convenient. The PIN 117 refers to a collection of all IoT devices connected within a network. The PIN 117 allows the user to control the environment, access data, automate tasks, and infer valuable information from the data. In a non-limiting example, the user may control a mode or angle of capturing video by a video-capturing device from outside a home, control a door lock of the home without being physically present with a key of the door lock, control a video content streaming of television from outside home or within the home via smartphone, adjust a temperature of an air conditioner from outside or inside of the home, .etc. The PIN or PINs 117 provides local connectivity between UEs and/or non-third generation partnership project (non-3GPP) devices.

According to an embodiment, the PIN 117 consists of a plurality of PIN Elements (PINE, for example, PINE-1 109, PINE-2 111, PINE-3 113, and PINE-4 115) that communicate using PIN Direct Connection or direct network connection and is managed locally using the PEMC 103. The plurality of PIN Elements may correspond to UEs and/or non-3GPP devices that form part of the PIN. Each PIN Element can be identified using a Unique identifier associated with the PIN. In a non-limiting example, the PINE-1 109 may correspond to the video-capturing device, PINE-2 111 may correspond to an image-capturing device, the PINE-3 113 may correspond to elec-tronically controllable door lock, and the PINE-4 may correspond to a display unit, such as television, digital screen, etc.

According to an embodiment, the PIN Elements with Gateway Capability (PEGCs, for example, PEGC-1 105, PEGC-2 107) have the Gateway Capability that provides means to the PIN Elements to register and access 5G network services. The PEGC may also help in communication between 2 PIN Elements that are not within the range to use direct communication. Therefore, the PEGC (that is, the PEGC-1 105, and the PEGC-2 107) is the PIN Element with the capability for performing as the gateway for communicating the PIN Elements with the 3GPP device outside the PIN or with PIN Elements of a first PIN with the PIN Elements with a second PIN, etc. In a non-limiting example, the PEGC-1 105 may correspond to a first PIN Element among the plurality of PIN Elements acting as the current PEGC and serving as the gateway node among the plurality of PIN Elements, and the PEGC-2 107 may correspond to a second PIN or new PEGC that may be capable of performing role of the PEGC in replacement of the PEGC-1 105 for serving as the gateway node among the plurality of PIN Elements based on the information available in the PIN profile and the PIN dynamic information.

The PIN profile relates to specific information or characteristics used to identify the PINEs or the users of the PIN 117. Therefore, the PIN profile generally relates to fixed usage policies or characteristics of the PIN 117. Alternatively, the PIN dynamic information maintains dynamic information relating to the configuration of the corresponding PIN 117. The corresponding PIN dynamic information is also available with the PIN MS 101. The dynamic information may include whenever there is a request from the PIN Element or a guest PIN Element requesting to join the PIN if a particular service is required to be offered by the PIN. The PIN dynamic information may include the following information:
1, A PIN Identifier for identifying the PIN 117;
2. A list of PIN Elements currently active in the PIN 117, and a corresponding PIN Element IDs, and their reachability information. The reachability information may be an IP address or any other information that can be used to reach a particular PIN Element;
3. PIN Element ID(s) and the reachability information of the PINE(s) acting as the PEMC 103;
4. PIN Element ID(s) and the reachability information of the PINE(s) acting as the current PEGC or PEGC-1 105;
5. For each PEGC, the list of PINE(s) for which the PEGC is serving as the gateway, and access control information for each PIN. The access control information includes the details of the session information of the PINE that is maintaining communication with 5G Core (5GC) or application servers. The access control information includes the IP addresses, Ports of the endpoints, application identifiers, etc. The access control information may contain all the details required to maintain the service continuity when another PINE may take up the role of the new PEGC;
6. A list of PIN Element IDs and the reachability information of the PINEs acting as Relay;
7. A list of Services currently offered by the PINE(s); and
8. A list of Guest PIN Elements present in the PIN and their reachability information.

The Reachability information could be an IP address or any other information that can be used to reach a particular PIN Element. The access control information contains the details of the session information PINE is maintaining with 5GC or application servers. The access control information may also contain the IP addresses, ports of the endpoints, application identifiers, etc. The access control information may also contain all the details required to maintain service continuity when another PINE takes up the role of the PEGC.

According to an embodiment, the PIN 117 typically works on wireless connectivity, such as Wi-Fi or Bluetooth, to communicate between devices and with the internet. The PIN 117 may also incorporate cloud services to store and process data, as well as artificial intelligence and machine learning algorithms to provide personalized insights and recommendations. The PIN 117 may connect with a network entity 119 for communicating with the PIN MS 101 or the UE 121.

According to an embodiment, the PIN MS 101 may be connected with one or more PINs 117. The PIN MS 101 is a central server for controlling and authenticating all transactions or communications of each of the one or more PINs 117 connected with the PIN MS 101. In a non-limiting example, a service provider such as Company XYZ may include only one PIN MS 101 for controlling all PINs 117 that are serviced by the Company XYZ network. Therefore, the PIN MS 101 may include the PIN dynamic information relating to each PIN 117 connected with the PIN MS 101.

According to an embodiment, the PEMC 103 is a PIN Element that has the capability to provide means for an authorized administrator to configure and manage the PIN 117. The PEMC 103 has the authorization to manage a network within the PIN 117 only. The PEMC 103 may support the credential and identity management requirements of the PIN 117. The PEMC 103 may include the PIN dynamic information of the PIN 117. The PEMC 103 includes at least one processor 123 for executing the instructions stored in a memory 125.

According to an embodiment, the at least one processor 123 (hereinafter referred to as “the processor”) may be operatively coupled to PEMC 103 for processing, executing, or performing a plurality of operations. Further, the processor 123 is communicatively coupled to the memory 125. In an embodiment, the processor 123 may include at least one data processor for executing processes of the PEMC 103. The processor 123 may include specialized processing units such as integrated system (bus) controllers, memory management control units, floating point units, graphics processing units, digital signal processing units, etc. In an embodiment, the processor 123 may include a central processing unit (CPU), a graphics processing unit (GPU), or both. The processor 123 may be one or more general processors, digital signal processors, application-specific integrated circuits, field-programmable gate arrays, servers, networks, digital circuits, analog circuits, combinations thereof, or other now-known or later developed devices for analyzing and processing data. The processor 123 may execute a software program, such as code generated manually (i.e., programmed) to perform the desired operation.

According to an embodiment, the memory 125 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The memory 125 is communicatively coupled with the processor 123 to store bitstreams or processing instructions for completing the process. Further, the memory 125 may include an operating system for performing one or more tasks of the system 100, as performed by a generic operating system in the communications domain. The memory 125 may also store data blocks generated by the PIN 117 for future processing.

According to an embodiment, the processor 123 may be configured to detect whether there is a requirement for a PEGC switchover or replacement from the current PEGC or PEGC-1 105 to a new PEGC or PEGC-2 107 based on an occurrence of one or more fault events in the current PEGC. The processor is further configured to determine that the new PEGC is capable of performing role of the PEGC for serving as the gateway node among the plurality of PIN Elements based on the information of the PIN profile and the PIN dynamic information available in the PEMC 103. Further, the processor 123 may be configured to transmit a request signal to the determined new PEGC for acting as the PEGC and serving as the gateway node among the plurality of PIN Elements. Upon transmitting the request, the processor may receive a response signal from the new PEGC in response to the transmitted request signal. If the received response signal indicates an acceptance of the request signal by the new PEGC to serve as the serving gateway node, the processor 123 is configured to send a notification message to each of the PIN Elements and the PIN MS 101 indicating that role of the current PEGC is being assigned to the new PEGC and the current PEGC is being released from the role of PEGC. The new PEGC or PEGC-2 107 may correspond to the second PIN Element among the plurality of PIN Elements in the PIN.

In an embodiment, during determining that the new PEGC is capable of performing the role of the PEGC for serving as the gateway node, the processor 123 may be configured to determine the new PEGC to serve as the PEGC for the PIN. The processor 123 is configured to determine the new PEGC for serving as the PEGC for the PIN based on the PIN dynamic information or PIN profile. During the initialization or registration of the PINE in the PIN 117, the corresponding PINE informs the PEMC 103 that the PINE is capable of acting as the PEGC in the future. Such information is stored in the PIN dynamic information and/or the PIN profile.

In an embodiment, during sending the notification message to the PIN MS and each of the PIN Elements, the processor 123 is further configured to update the PIN dynamic information by including information indicating the transfer of the role from the current PEGC to the new PEGC and the new PEGC to be served as the gateway node. Thereby, the processor 123 is further configured to send the notification message to the PIN MS 101 and each of the PIN Elements by including the updated PIN dynamic information. Further, the processor is configured to send the notification message to each of the plurality of PIN Elements that are previously being served by the current PEGC or the PEGC-1 105.

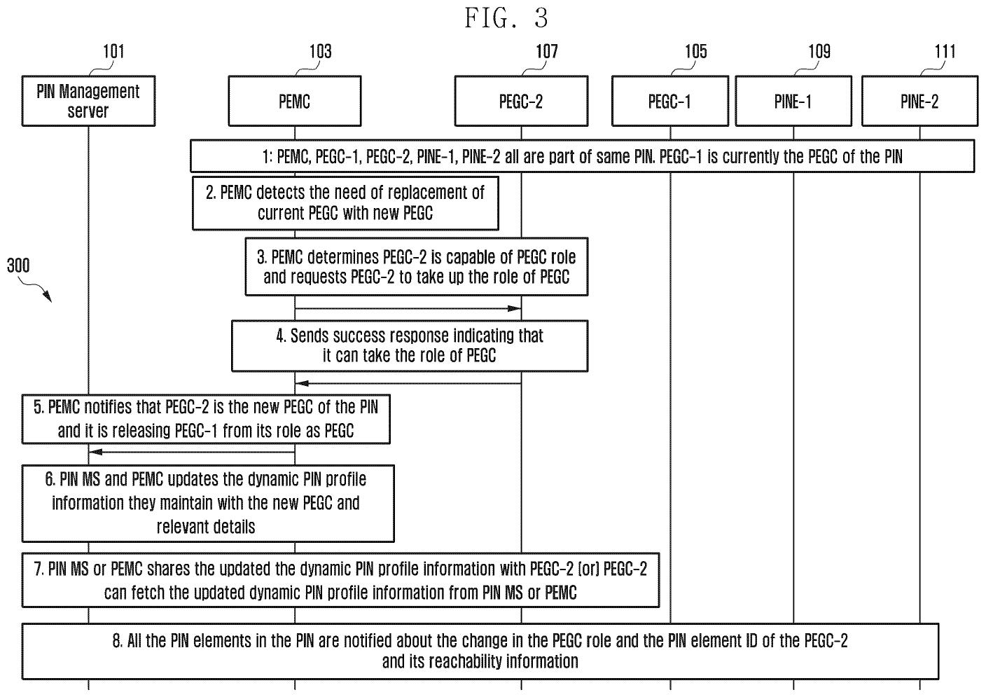

In one or more embodiments described herein, the PIN MS 101 may also include at least one processor 127 and a memory 129 as illustrated in FIG. 1. The at least one processor 127 may be configured to perform one or more methods as illustrated in FIG. 3 through FIG. 11. The configuration of the at least one processor 127 may be same as that of the processor 123 and therefore a detailed description of the same is omitted herein for the sake of brevity of the present disclosure.

In an embodiment, the network entity 119 refers to any entity that performs one or more functionalities of a network connection between the PIN 117, the PIN MS 101, and/or the UE 121. The network entity 119 may be further configured to connect with external media, memory, or any other components in a system, or combinations thereof. The network connection may be a physical connection, such as a wired Ethernet connection, or may be established wirelessly. Likewise, the additional con-nections with other components of the system 100 may be physical or may be established wirelessly.

In an embodiment, the UE 121 may correspond to devices and equipment used by end users to access and utilize various services including network services. The UE 121 can be mobile, smartphone, tablet, desktop, laptop, computing device, or any other device that may connect to the network and communicate with other devices.

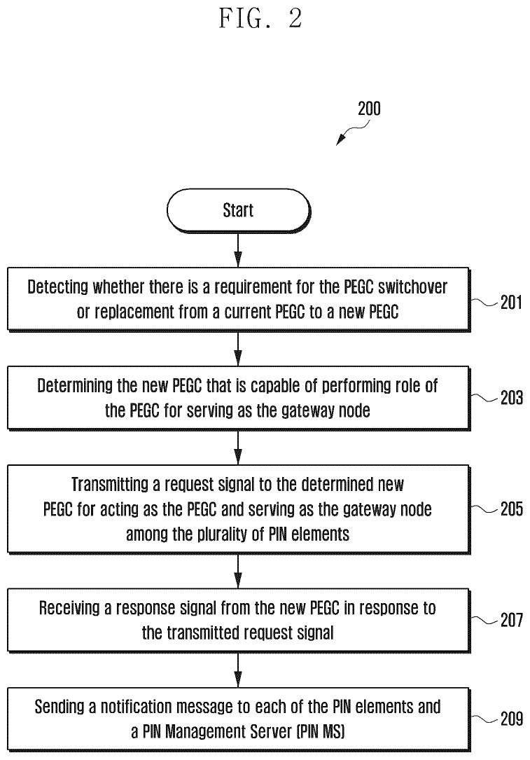

FIG. 2 illustrates a flow chart of a first method for managing a PIN Element with Gateway Capability (PEGC) switchover or replacement in context with PIN Elements of the PIN, in accordance with an embodiment of the present disclosure. FIG. 2 illustrates the method 200 for the switchover or replacement of the current PEGC in the PIN 117. The method initializes its execution from the start block of FIG. 2. The communication device may correspond to the PEMC 103.

The method 200 comprises detecting (at Step 201) whether there is a requirement for the PEGC switchover or replacement from a current PEGC to a new PEGC based on an occurrence of one or more fault events in the current PEGC. The current PEGC or PEGC-1 105 may correspond to the first PIN Element among a plurality of PIN Elements in the PIN. The current PEGC is serving as a gateway node for all the PINE elements within the PIN 117. The one or more fault events may correspond to at least one of a hardware failure of the current PEGC, a hardware crash of the current PEGC, a sudden drain in remaining battery power of the current PEGC, an expiration of service duration of the current PEGC while serving as the gateway node, or an indication of relinquishing a role of the gateway node by the current PEGC. In a non-limiting example, the user may wish to stream a video from the UE 121 to the PINE-4 115 while the user is outside the coverage area of the PIN 117. To stream the video from the UE to the PINE-4 115, the UE 121 may be in communication with the PINE-4 115 of the PIN 117 through the current PEGC (PEGC-1 105) and the network entity 119. While streaming the video from the UE 121 to the PINE-4 115, the PEMC 103 may be configured to detect that there are one or more fault events in the current PEGC. Thereby, there is a requirement for a switchover or replacement of the current PEGC such that there is no delay or service interruption due to the unavailability of the current PEGC. The flow of the method now proceeds to Step 203.

At step 203, the method 200 further comprises determining the new PEGC that is capable of performing role of the PEGC for serving as the gateway node among the plurality of PIN Elements. The new PEGC is determined based on the information available in the PIN profile and the PIN dynamic information. Upon determining the new PEGC, the method further comprises determining that the new PEGC may have to serve as the gateway node or PEGC of the PIN 117. The new PEGC corresponds to the second PIN Element among the plurality of PIN Elements in the PIN. In a non-limiting example, continuing from the previous example related to the streaming of video, the PEMC 103 may determine the PEGC-2 107 as the new PEGC for serving as the gateway node based on the information available in the PIN profile and the PIN dynamic information. The flow of the method now proceeds to Step 205.

At step 205, the method 200 further comprises transmitting a request signal to the determined new PEGC for acting as the PEGC and serving as the gateway node among the plurality of PIN Elements. Upon determining the new PEGC for acting as the gateway node, the method includes transmitting the request signal to the new PEGC for acting as the gateway node. In a non-limiting example, continuing from the previous example related to the streaming of video, the PEMC 103 may transmit the request signal to the PEGC-2 107 after determining that the PEGC-2 107 is capable of performing as the gateway node for the PIN 117. The flow of the method now proceeds to Step 207.

At step 207, the method 200 further comprises receiving a response signal from the new PEGC in response to the transmitted request signal. The method includes receiving the response signal from the PEGC-2 107 based on the transmitted request signal to the PEGC-2 107. In a non-limiting example, continuing from the previous example related to the streaming of video, the PEMC 103 may receive the response signal from the PEGC-2 107 based on the transmitted request signal to the PEGC-2 107. The flow of the method now proceeds to Step 209.

At step 209, the method 200 further comprises sending a notification message to each of the PIN Elements and a PIN Management Server (PIN MS) if the received response signal indicates an acceptance of the request signal by the new PEGC to serve as the serving gateway node. The notification message indicates that the role of the current PEGC is being assigned to the new PEGC and the current PEGC is being released from the role of PEGC. The notification message includes the information regarding the switchover or replacement of the PEGC-1 105 (current PEGC) with the PEGC-2 107 (new PEGC). The notification message may comprise information related to a change in the gateway node (such as, from the PEGC-1 105 to the PEGC-2 107), iden-tification information associated with the new PEGC (i.e., the PEGC-2 107), reachability information of the new PEGC (i.e., the PEGC-2 107), and serving duration of the new PEGC (i.e., the PEGC-2 107) as the gateway node. The serving duration denotes the timeframe for which the PEGC-2 107 may be performed as the gateway node for the PIN 117. The method of sending the notification message further comprises updating the PIN dynamic information by including information indicating the transfer of the role from the current PEGC to the new PEGC and the new PEGC to be served as the gateway node. The method also includes sending the notification message to all PIN Elements that are previously being served by the current PEGC. In a non-limiting example, continuing from the previous example related to the streaming of video, the PEMC 103 may send the notification message to each PIN Element including PINE-4 115 that is previously served by the PEGC-1 105. Once the PINE-4 115 receives the notification regarding the new gateway node as the PEGC-2 107, the PINE-4 115 connects to the UE via the PEGC-2 107 for continuing streaming of the video from the UE 121. Therefore, the user does not experience service disruption of the video streaming or any lag in the video streaming.

FIG. 3 illustrates a line diagram of the first method for the PEGC switchover or the PEGC replacement in context with PIN Elements of the PIN, in accordance with an embodiment of the present disclosure. The system 100 includes the PIN MS 101, the PEMC 103, the PEGC-1 105, the PEGC-2 107, and a plurality of PIN Elements (PINE-1 109, PINE-2 111, and PINE-3 113). FIG. 3, in particular, depicts the first method 300 including a sequence of events (step 1 to step 8) for the PEGC switchover or the PEGC replacement in the PIN 117.

According to the embodiment of the first method, FIG. 3 illustrates the method 300 in a case where the PEGC-2 107 PIN Element has indicated that it has the capability to anchor/act as the PEGC/gateway node for the PIN during registration/join process. Further, information regarding the capability of the PEGC-2 107 for acting as the gateway node is recorded in the PIN dynamic information. Also, the PIN dynamic information is available with the PEMC 103. Further, the method 300 is performed if the PEGC-1 105 which is currently assigned with the PEGC role is no longer available either due to crash/power drain or its duration to act as PEGC is expiring.
In step 1 of method 300, the PEMC 103, the PEGC-2 107, the PEGC-1 105, the PINE-1 109, and the PINE-2 111 are part of the same PIN 117. The PEGC-1 105 is currently performing the role of the PEGC of the PIN 117.
In step 2 of method 300, The current PEGC may not be in a position to indicate or request the PIN MS 101 or the PEMC 103 regarding the change of role of the current PEGC due to any fault event. Therefore, the PEMC 103 may detect that there is a need to replace the PEGC role which is currently assigned to PEGC-1 105 as the gateway node. More particularly, The PEMC 103 may identify that the PEGC-1 105 is down or crashes or duration to act as PEGC is ending shortly.
In step 3 of method 300, the PEMC 103 determines that the new PIN Element can take up the role of PEGC or gateway node based on the information available in the PIN profile or PIN dynamic information with the PEMC 103. The new PIN Element may correspond to the PEGC-2 107. Upon determining the new PIN Element, the PEMC 103 requests the PEGC-2 107 to take the role of PEGC.
In step 4 of method 300, the PEGC-2 107 accepts or decides to take up the role of PEGC and sends the success response to the PEMC 103.
In step 5 of method 300, the PEMC 103 notifies the PIN MS 101 that PEGC-1 105 is getting released from the PEGC role, and the PEGC-1 105 is no longer acting as PEGC of the PIN 117. Further, the PEMC 103 notifies the PIN MS 101 that the PEGC-2 107 is assigned with the PEGC role of the PIN 117.
In step 6 of method 300, the PIN MS 101 and the PEMC 103 update the PIN dynamic information including the details of the change in the PEGC role and relevant details of the PEGC-2 107.
In step 7 of method 300, the PIN MS 101 or the PEMC 103 shares the updated PIN dynamic information with the PEGC-2 107. Alternatively, the PEGC-2 107 may fetch the updated PIN dynamic information from the PIN MS 101 or the PEMC 103.
In step 8 of method 300, all the PIN Elements in the PIN 117 are notified about the change in the PEGC and are provided with the details like PIN Element ID of the PEGC-2 107, PIN ID, and the reachability information of the PEGC-2 107. More particularly, The PEMC 103 notifies all the PINEs in the PIN about the change in the PIN Element acting as the PEGC and reachability information of the PEGC-2 107.

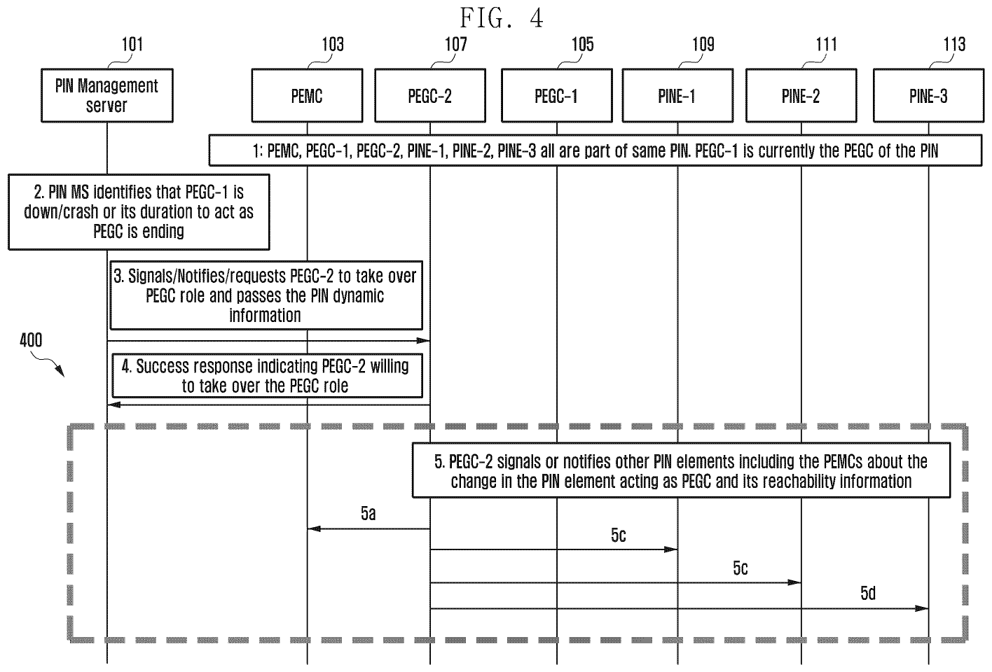

FIG. 4 illustrates a line diagram of a second method for the PEGC switchover or the PEGC replacement in context with PIN Elements of the PIN, in accordance with an embodiment of the present disclosure. The system 100 includes the PIN MS 101, the PEMC 103, the PEGC-2 107, the PEGC-1 105, and a plurality of PIN Elements (i.e., the PINE-1 109, the PINE-2 111, and the PINE-3 113).

In the PIN 117, there may be more than one PINEs, which may be assigned the role of PEGC for serving a set of PINEs. If the current PEGC goes down or crashes, it is necessary to assign the role of the PEGC to another PINE as the new PEGC. Thereby, the new PEGC may start serving the PINEs which were being served by the current PEGC. In this description, the procedures and methods are illustrated with the current PEGC (PEGC-1 105) and another PINE (new PEGC or PEGC-2 107) taking the role of PEGC. For example, if the PEGC-1 105 is serving PIN Elements the PINE-1 109, the PINE-2 111, and the PINE-3 113 when the PEGC-1 105 is down or crashed, only the PINE-1 109, the PINE-2 111, and the PINE-3 113 are impacted. So, when the new PINE (e.g., the PEGC-2 107) takes the role of the PEGC, the PINE-1 109, the PINE-2 111, the PINE-3 113, the PEMC 103, and PIN MS 101 are notified about the change and the relevant/required information is shared to the PEGC-2 107 in order to start serving the PINE-1 109, the PINE-2 111, and the PINE-3 113 and avoid service disruption to these PIN Elements. Alternatively, the information relating to the change of role to the new PEGC (the PEGC-2 107) may be shared with all PIN Elements within the PIN 117 along with the PEMC 103 and the PIN MS 101.

In each of the procedures explained below in the embodiments described below, the PIN MS 101 and the PEMC 103 update the PIN dynamic information. Further, the PIN MS 101 and the PEMC 103 maintain the information of the new PEGC taking over the role of the PEGC and the list of PINEs that is being served by the current PEGC before sharing the PIN dynamic information to the PINE (i.e., the new PEGC) taking up the role of the PEGC.

According to the embodiment of the second method of the present disclosure, FIG. 4 illustrates the method 400 for the PEGC switchover or the PEGC replacement in the PIN 117. The embodiment of the second method 400 includes a sequence of events (step 1 to step 5) for the PEGC switchover or the PEGC replacement in the PIN 117. The embodiment of the second method 400 is performed in cases where the PEGC-2 107 has already requested to act as the PEGC or indicated that the PEGC-2 107 is capable to take the role of the PEGC during a registration process. The PIN dynamic information about the PIN which includes the indication of the PEGC-2 during registration is available at the PIN Management Server 101. Further, the embodiment of the second method 400 is performed in cases when the PEGC-1 105 is currently in charge of the PEGC role of the PIN. The sequence of events (step 1 to step 5) is illustrated as follows:

In step 1 of method 400, the PEMC 103, the PEGC-1 105, the PEGC-2 107, the PINE-1 109, the PINE-2 111, and the PINE-3 113 all are part of the same PIN 117 and the PEGC-1 105 is currently performing the role of the PEGC of the PIN 117.

In step 2 of method 400, the PIN MS 101 identifies, based on the occurrence of one or more fault events in the PEGC-1 105, that the PEGC-1 105 is down or crashed or duration to perform as the PEGC is expiring soon.

In step 3 of method 400, on identifying that the current PEGC is down or crashed, the PIN MS 101 looks into the PIN profile and the PIN dynamic information to identify the new PINE which can take up the role of PEGC (here PEGC-2 107 PIN Element). Thereby, the PIN MS 101 transmits a signal to the PINE to take over as the new PEGC by providing the necessary details about the PIN i.e., the PIN dynamic information. In another embodiment, the PINE can fetch the PIN dynamic information from the PIN MS 101 on receiving the signal to take up the role of the new PEGC. Further, in a case, if the PEGC-2 107 element rejects the request, then PIN MS 101 further needs to look for another PINE which can take up the role of the PEGC.

In step 4 of method 400, the PEGC-2 107 signals the success response to the PIN MS 101 in a case if the PEGC-2 107 PINE decides to take up the role of the PEGC.

In step 5 of method 400, once the takeover/switchover or replacement process is successful, the PEGC-2 107 signals all the PINEs (PINEs which were being served by the PEGC-1 105 earlier) in the PIN including the PEMC, as shown in steps 5a, 5b, 5c, and 5d, about the change in the PIN Element acting as the PEGC and reachability information of the PEGC-2 107.

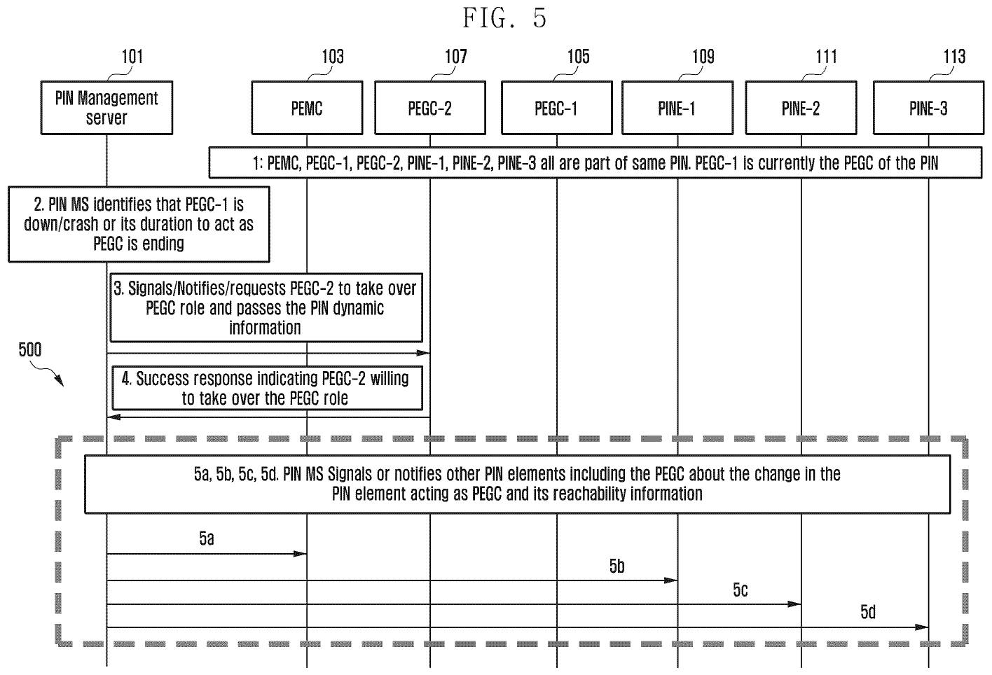

FIG. 5 illustrates a line diagram of a third method for the PEGC switchover or the PEGC replacement in context with PIN Elements of the PIN, in accordance with an embodiment of the present disclosure. FIG. 5, in particular, depicts the third method 500 including a sequence of events (step 1 to step 5) for the PEGC switchover or the PEGC replacement in the PIN 117. The third method 500 is being performed in a case where the PEGC-2 107 has already requested to act as the PEGC or indicated that the PEGC-2 107 is capable to take the role of the PEGC during a registration process. Further, the third method 500 is being performed if the PIN dynamic information about the PIN including the indication of the PEGC-2 is available at the PIN Management Server 101. Furthermore, the third method 500 is being performed if the PEGC-1 105 is currently in charge of the PEGC role of the PIN.

In step 1 of method 500, the PEMC 103, the PEGC-1 105, the PEGC-2 107, the PINE-1 109, the PINE-2 111, and the PINE-3 113 all are part of the same PIN 117 and the PEGC-1 105 is currently performing the role of the PEGC of the PIN 117.

In step 2 of method 500, the PIN MS 101 identifies, based on the occurrence of one or more fault events in the PEGC-1 105, that the PEGC-1 105 is down or crashed or its duration to perform as the PEGC is expiring soon.

In step 3 of method 500, on identifying that the current PEGC is down or crashed or going down in some time, the PIN MS 101 looks into the PIN profile and the PIN dynamic information to identify the new PINE which can take up the role of PEGC (here PEGC-2 107 PIN Element). Thereby, the PIN MS 101 transmits a signal to the PINE to take over as the new PEGC by providing the necessary details about the PIN i.e., the PIN dynamic information. In another embodiment, the PINE can fetch the PIN dynamic information from the PIN MS 101 on receiving the signal to take up the role of the new PEGC. Further, in a case, if the PEGC-2 107 element rejects the request, then PIN MS 101 further needs to look for another PINE which can take up the role of the PEGC.

In step 4 of method 500, the PEGC-2 107 signals the success response to the PIN MS 101 in a case if the PEGC-2 107 PINE decides to take up the role of the PEGC.

In step 5 of method 500, once the takeover/switchover process is successful, the PIN MS 101 signals all the PINEs (PINEs which were being served by the PEGC-1 105 earlier) in the PIN including the PEMC 103, as shown in steps 5a, 5b, 5c, and 5d, about the change in the PIN Element acting as the PEGC and reachability information of the new PEGC. The signal to the other PIN Elements which are not reachable directly from the PIN MS 101 is sent via the PEGC. The PEGC routes the notification signal to the PIN Elements inside the PIN. Further, if in a case the PEGC-2 107 element rejects the request, then PIN MS 101 needs to look for other PINEs which can take up the role of the PEGC.

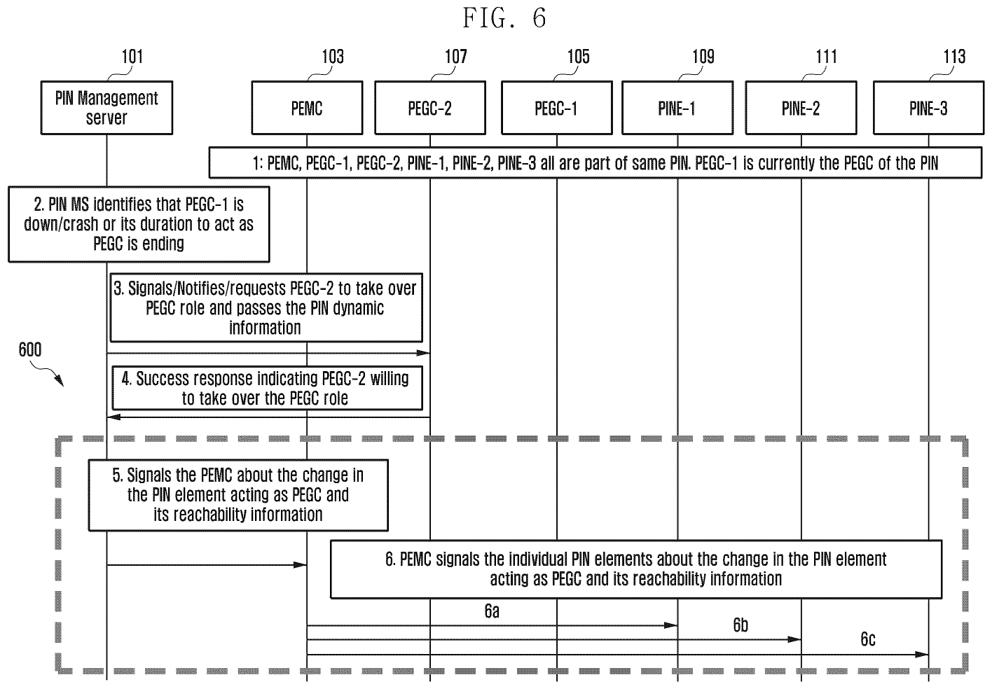

FIG. 6 illustrates a line diagram of a fourth method for the PEGC switchover or the PEGC replacement in context with PIN Elements of the PIN, in accordance with an embodiment of the present disclosure. FIG. 6, in particular, depicts the method 600 including a sequence of events (step 1 to step 6) for the PEGC switchover or the PEGC replacement in the PIN 117. The fourth method 600 is being performed in case where the PEGC-2 107 has already requested to perform as the PEGC or indicated that it is capable to take the role of the PEGC during a registration process. Further, the fourth method 600 is being performed if the dynamic information about the PIN, including the information of intimation of the PEGC-2 107 during registration, is available at the PIN Management server 101, and the PEGC-1 105 is currently in charge of PEGC role of the PIN. The sequence of events (step 1 to step 6) of the fourth method 600 is illustrated as follows:

In step 1 of method 600, the PEMC 103, the PEGC-1 105, the PEGC-2 107, the PINE-1 109, the PINE-2 111, and the PINE-3 113 all are part of the same PIN 117 and the PEGC-1 105 is currently performing the role of the PEGC of the PIN 117.

In step 2 of method 600, the PIN MS 101 identifies, based on the occurrence of one or more fault events in the PEGC-1 105, that the PEGC-1 105 is down or crashed or duration to perform as the PEGC is expiring soon.

In step 3 of method 600, on identifying that the current PEGC is down or crashed, the PIN MS 101 looks into the PIN profile and the PIN dynamic information to identify the new PINE which can take up the role of PEGC (here PEGC-2 107 PIN Element). Thereby, the PIN MS 101 transmits a signal to the PINE to take over as the new PEGC by providing the necessary details about the PIN i.e., the PIN dynamic information. In another embodiment, the PINE can fetch the PIN dynamic information from the PIN MS 101 on receiving the signal to take up the role of the new PEGC. Further, in a case, if the PEGC-2 107 element rejects the request, then PIN MS 101 further needs to look for another PINE which can take up the role of the PEGC.

In step 4 of method 600, the PEGC-2 107 signals the success response to the PIN MS 101 in a case if the PEGC-2 107 PINE decides to take up the role of the PEGC.

In step 5 of method 600, once the takeover/switchover process is successful, the PIN MS 101 signals the PEMC 103 about the change in the PIN Element acting as the PEGC and reachability information of the new PEGC, i.e., the PEGC-2 107.

In step 6 of method 600, the PEMC 103, on receiving the signal about the change in PEGC, notifies all other PINEs (PINEs which were being served by the PEGC-1 105 earlier), as shown in steps 6a, 6b, and 6c, about this change and the new PEGC's (the PEGC-2 107) reachability information. The PEMC 103 has a list of PIN Elements that are in active state and connected to the PIN. According to another embodiment, the PEMC 103 may also fetch the PIN dynamic information containing the details of the PIN Elements from PIN MS 101.

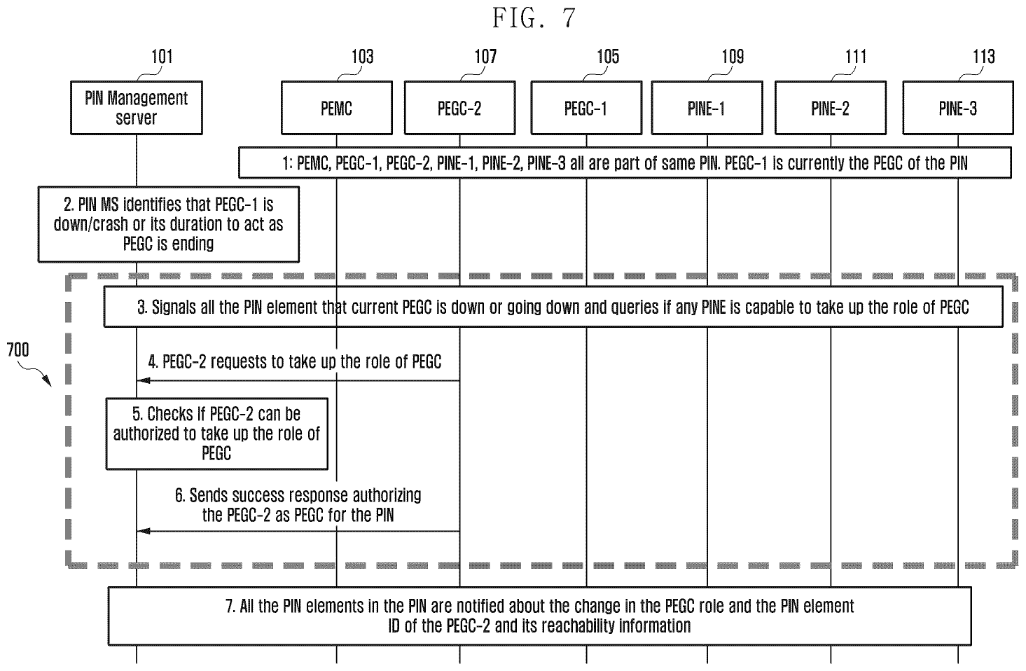

FIG. 7 illustrates a line diagram of a fifth method for the PEGC switchover or the PEGC replacement in context with PIN Elements of the PIN, in accordance with an embodiment of the present disclosure. FIG. 7, in particular, depicts the method 700 including a sequence of events (step 1 to step 7) for the PEGC switchover or the PEGC replacement in the PIN 117. The fifth method 700 is performed in a case where the dynamic information about the PIN is available at the PIN Management server 101 and the PEGC-1 105 is currently in charge of the PEGC role of the PIN. The sequence of events (step 1 to step 7) of the fifth method is illustrated as follows:

In step 1 of method 700, the PEMC 103, the PEGC-1 105, the PEGC-2 107, the PINE-1 109, the PINE-2 111, and the PINE-3 113 all are part of the same PIN 117 and the PEGC-1 105 is currently performing the role of the PEGC of the PIN 117.

In step 2 of method 700, the PIN MS 101 identifies, based on the occurrence of one or more fault events in the PEGC-1 105, that the PEGC-1 105 is down or crashed or its duration to perform as the PEGC is expiring soon.

In step 3 of method 700, on identifying that the current PEGC (i.e., the PEGC-1 105) is down/crashed, the PIN MS 101 transmits signals or notifies all the PIN Elements currently active in the PIN that the PEGC role is being changed and requests if any of the PIN Elements can take the role of the PEGC.

In step 4 of method 700, on receiving the signal from the PIN MS 101, the PEGC-2 107 requests the PIN MS 101 that the PEGC-2 107 may act as the PEGC. In another embodiment, two or more PIN Elements may request the PIN MS 101 to take the role of the PEGC. Upon receiving the requests from the two or more PIN Elements, the PIN MS 101 may decide which PIN Element can be authorized to take the role of the PEGC.

In step 5 of method 700, the PIN MS 101 checks whether the PEGC-2 107 may be authorized to take the role of the PEGC.

In step 6 of method 700, if the PEGC-2 107 is authorized, then the PIN MS 101 sends the success response to the PEGC-2 107 to indicate that the PEGC-2 107 is authorized to take the role of the PEGC.

In step 7 of method 700, all the PIN Elements in the PIN 117 are notified about the change in the PEGC and are provided with the details like PIN Element ID of the new PEGC, PIN ID, and the reachability information of the new PEGC. The PIN Elements may be notified in any of the following ways as mentioned below:
The PIN MS 101 notifies the PEMC 103 about the change in the PEGC role, and thereby the PEMC 103, in turn, notifies all the PIN Elements (PINEs which were being served by the PEGC-1 105 earlier) in the PIN about the change in the PEGC role and the corresponding information like PINE ID of the PEGC, reachability information, duration of its role as PEGC, etc; or
The PIN MS 101 notifies the PEMC 103 about the change in the PEGC role and also notifies all the PIN Elements (PINEs which were being served by the PEGC-1 105 earlier). The notification to the individual PIN Elements (without having any 3GPP access) are routed via the PEGC since PIN MS cannot reach the PIN Elements inside the PIN directly if they are non-3GPP devices/UE; or
The new PINE taking the role of PEGC notifies all the PIN Elements (PINEs which were being served by the PEGC-1 105 earlier) including the PEMC that it is taking the role of PEGC and reachability information of the new PEGC (PEGC-2 107).

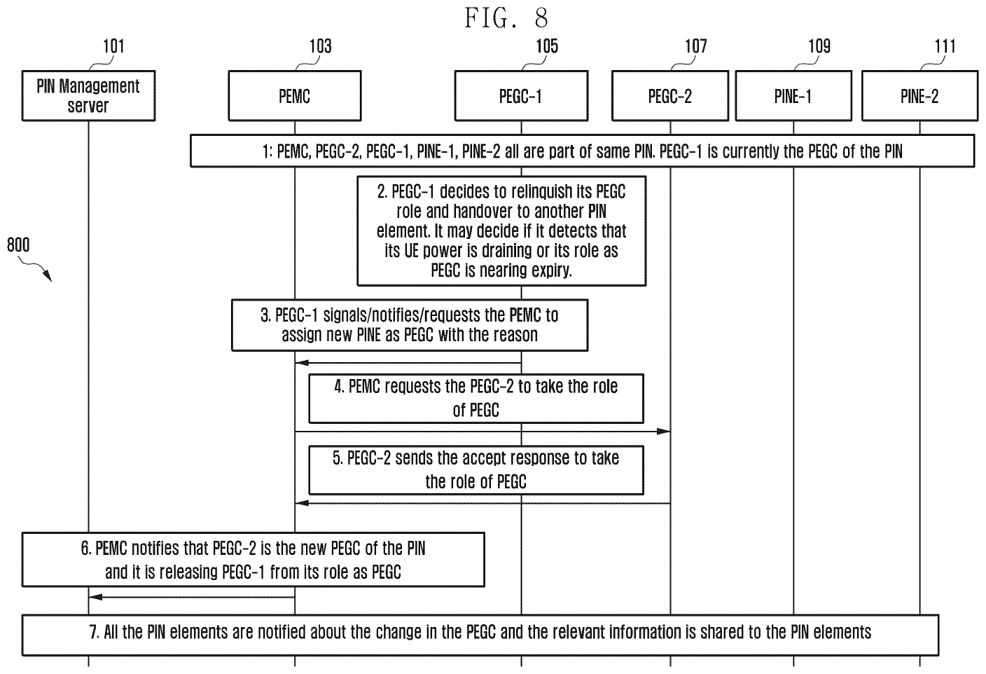

FIG. 8 illustrates a line diagram of a sixth method for the PEGC switchover or the PEGC replacement in context with PIN Elements of the PIN, in accordance with an embodiment of the present disclosure. FIG. 8, in particular, depicts the method 800 including a sequence of events (step 1 to step 7) for the PEGC switchover or the PEGC replacement in the PIN 117. The sixth method 800 is performed in case where the PEGC-2 107 PIN Element has indicated information that the PEGC-2 107 has the capability to anchor/act as the PEGC for the PIN during registration/join process. The information of the PEGC-2 107 is recorded in the PIN dynamic information. In addition, the sixth method 800 is performed in case the PEGC-1 105 is proactively relinquishing and handing over the PEGC role to another PIN Element. The sequence of events (step 1 to step 5) of the sixth method 800 is illustrated as follows:

In step 1 of method 800, the PEMC 103, the PEGC-1 105, the PEGC-2 107, PINE-1 109, and PINE-2 111 are part of the same PIN 117. The PEGC-1 105 is currently acting as the PEGC of the PIN 117.

In step 2 of method 800, the PEGC-1 105 decides to relinquish the PEGC role and handover to another PIN Element. The PEGC-1 105 may decide if the PEGC-1 105 detects that power of the PEGC-1 105 is draining or the role as PEGC is nearing expiry or for any other fault events or reasons.

In step 3 of method 800, the PEGC-1 105 signals/notifies/requests the PEMC 103 to assign a new PINE as the PEGC for the PIN 117 since the current PEGC cannot be acting as PEGC anymore.

In step 4 of method 800, the PEMC 103, by looking into the PIN dynamic information, detects that PEGC-2 107 is capable of taking up the PEGC role. The PEMC 103 requests the PEGC-2 107 to take up the role of the PEGC.

In step 5 of method 800, the PEGC-2 107 accepts to take up the role of the PEGC and sends a success response. After accepting the PEGC role, the PEGC-2 107 needs to retrieve information, such as the PIN profile, PIN dynamic information, and active profile information of each active PIN Element either from the PIN MS 101 or from the PEMC 103. Alternatively, the PEMC 103 or the PIN MS 101 may transmit the information to the PEGC-2 107.

In step 6 of method 800, the PEMC 103 notifies the PIN MS 101 that the PEGC-1 105 has relinquished the role as the PEGC and the PEGC-2 107 is the new PEGC of the PIN 117. Notifying and releasing the role of the PEGC can be made as part of a single signal or the PEGC-1 105 may send separate signals for notifying and releasing.

In step 7 of method 800, all the PIN Elements in the PIN 117 are notified about the change in the PEGC and are provided with the details like PIN Element ID of the PEGC, PIN ID, and the reachability information of the new PINE taking the role of PEGC. The PIN Elements can be notified in any of the following ways as mentioned below:
The PIN MS 101 notifies the PEMC 103 about the change in the PEGC role and the PEMC 103, in turn, notifies all the active PIN Elements (PINEs which were being served by the PEGC-1 105 earlier) in the PIN 117 about the change in the PEGC role and the corresponding information like PINE ID of the PEGC, reachability information of the new PEGC, duration of its role as the PEGC, etc.; or
The PIN MS 101 notifies the PEMC 103 about the change in the PEGC role and also notifies all the active PIN Elements (PINEs that were being served by the PEGC-1 105 earlier). Notification to the individual PIN Elements (without any 3GPP access) may be routed via the PEGC since the PIN MS 101 cannot reach the PIN Elements inside the PIN directly; or
The new PINE taking the role of PEGC notifies all the PIN Elements (PINEs which were being served by the PEGC-1 105 earlier) including the PEMC 103 that the new PEGC is taking the role of the PEGC and reachability information of the new PEGC; or
The PEMC 103 can notify all the PIN Elements (PINEs which were being served by the PEGC-1 105 earlier) that the PEGC-2 107 is the new PEGC and reachability information of the PEGC-2 107.

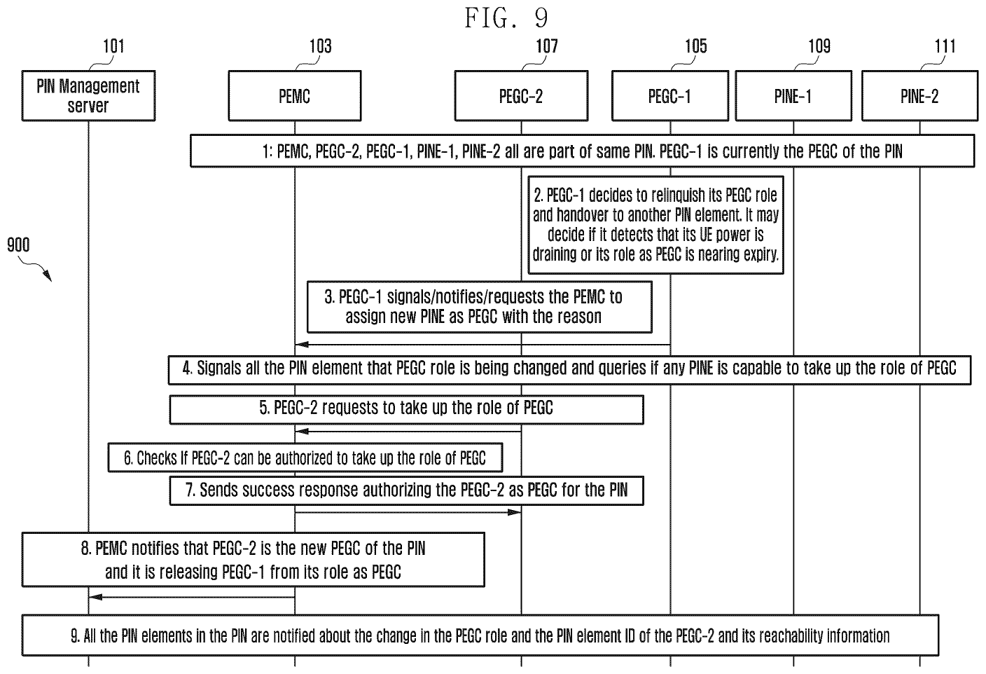

FIG. 9 illustrates a line diagram of a seventh method for the PEGC switchover or the PEGC replacement in context with PIN Elements of the PIN, in accordance with an embodiment of the present disclosure. FIG. 9, in particular, depicts the seventh method 900 including a sequence of events (step 1 to step 9) for the PEGC switchover or the PEGC replacement in the PIN. The seventh method 900 is performed if the PEGC-2 107 PIN Element has indicated that the PEGC-2 107 has the capability to anchor/act as the PEGC for the PIN during registration/join process and the information regarding the indication of the PEGC-2 107 is recorded in the PIN dynamic information. Further, the seventh method 900 is performed if the PEGC-1 105 is proactively relinquishing and handing over the PEGC role to another PIN Element.

The sequence of events (step 1 to step 9) of the seventh method 900 is illustrated as follows:
In step 1 of method 900, the PEMC 103, the PEGC-1 105, the PEGC-2 107, PINE-1 109, and PINE-2 111 are part of the same PIN 117. The PEGC-1 105 is currently acting as the PEGC of the PIN 117.
In step 2 of method 900, the PEGC-1 105 decides to relinquish the PEGC role and handover to another PIN Element. The PEGC-1 105 may decide if the PEGC-1 105 detects that power of the PEGC-1 105 is draining or the role as PEGC is nearing expiry or for any other fault events or reasons.
In step 3 of method 900, the PEGC-1 105 signals/notifies/requests the PEMC 103 to assign a new PINE as the PEGC for the PIN 117 since the current PEGC cannot be acting as PEGC anymore.
In step 4 of method 900, the PEMC 103 signals all the PIN Elements that the PEGC role is going to change and queries if any PINE is capable of taking up the role of the PEGC. The signal contains the PIN ID, the identifier of the PEGC-1 105, etc.
In step 5 of method 900, the PEGC-2 107 on receiving the signal as in step-4 decides to take up the role of the PEGC and sends the request to the PEMC 103 to indicate that the PEGC-2 107 may take up the role of the PEGC.
In step 6 of method 900, the PEMC 103 checks the PIN information/PIN profile/PIN dynamic information to verify whether the PEGC-2 107 can be authorized to take the role of the PEGC. According to another embodiment of the present disclosure, the PEMC 103 can query the PIN MS 101 whether the PEGC-2 107 can be authorized to take the role of the PEGC.
In step 7 of method 900, if the PEGC-2 107 is authorized to take the role of PEGC, the PEMC 103 sends a success response to the PEGC-2 107. If not the PEMC 103 sends a failure response and thereby waits for requests from other PIN Elements to take the role of PEGC and do not proceed with the next steps. On receiving the success response, the PEGC-2 107 needs to retrieve the information from the PIN profile, PIN dynamic information, and active profile information of each active PIN Element either from the PIN MS 101 or from the PEMC 103. Alternatively, the information may be pushed to the PEGC-2 107 by PEMC 103 or PIN MS 101.
In step 8 of method 900, the PEMC 103 notifies the PIN MS 101 that PEGC-1 105 has relinquished the role of PEGC, and the PEGC-2 107 is the new PEGC of the PIN.
In step 9 of method 900, all the PIN Elements in the PIN are notified about the change in the PEGC and are provided with the details like PIN Element ID of the PEGC-2 107, PIN ID, and the reachability information of the PEGC-2 107. The PIN Elements can be notified in any of the following ways:
   The PIN MS 101 notifies the PEMC 103 about the change in the PEGC role and the PEMC 103, in turn, notifies all the PIN Elements (PINEs which were being served by the PEGC-1 105 earlier) in the PIN about the change in the PEGC role and the corresponding information like PINE ID of the PEGC, reachability information, duration of the role as PEGC, etc.
   The PIN MS 101 notifies the PEMC 103 about the change in the PEMC role and also notifies all the PIN Elements (PINEs that were being served by the PEGC-1 105 earlier). The notification to the individual PIN Elements (without 3GPP access) may be routed via the PEGC since PIN MS 101 cannot reach the PIN Elements inside the PIN directly.
   The new PINE taking the role of PEGC notifies all the PIN Elements (PINEs that were being served by the PEGC-1 105 earlier) that the PEGC-2 107 is taking the role of the PEGC and the new PEGC's reachability information.

According to another embodiment of the present disclosure, the PEMC 103 can detect that the PINE currently acting as one of the PEGCs is no longer available or the duration to act as PEGC is expiring. On detecting, the PEMC 103 can implement any of the following steps to identify the PINE which can be assigned the role of PEGC:
The PEMC 103 can look into the PIN profile/PIN dynamic information to identify the PINE which is capable of taking the role of PEGC; or
Broadcast or signals other PIN Elements to query whether any PINE is willing to take the role of PEGC. When a PINE requests to take the role of PEGC, the PEMC 103 may authorize whether the requesting PINE can be assigned the role of the PEGC by looking into the PIN profile/PIN dynamic information or by querying the PIN MS 101; or
Query the PIN MS 101 to know which PINE can be assigned the role of the PEGC.

Further, once the PINE which can be assigned the role of PEGC is detected by the PEMC 103, all other PINEs may be notified about the role change by any of the mechanisms described in the previous procedures, i.e., as described in FIG. 3, FIG. 8, FIG. 9. The PIN MS 101 and the PEMC 103 updates the PIN dynamic information that is maintained with the details of the new PINE taking the role of PEGC and the list of PINEs that needs to be served by the new PEGC and with the reachability information of each PINEs and the details of 5G services and PIN application services they are currently using. Also, the PIN profile/the PIN dynamic information can be made available to the PINE taking the role of PEGC by any of the mechanisms described in the previous procedures, for example, as described in any of FIGS. 3 to 9.

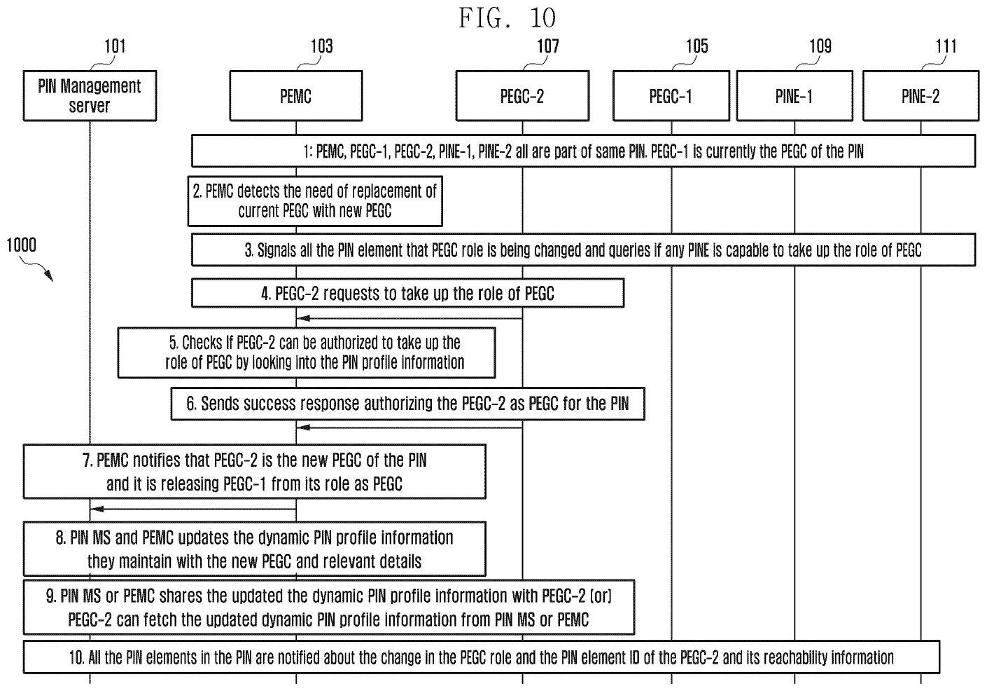

FIG. 10 illustrates a line diagram of an eighth method for the PEGC switchover or the PEGC replacement in context with PIN Elements of the PIN, in accordance with an embodiment of the present disclosure. FIG. 10, in particular, depicts the eighth method 1000 including a sequence of events (step 1 to step 10) for the PEGC switchover or the PEGC replacement in the PIN. The eighth method 1000 is performed in case where the PEGC-2 107 PIN Element has indicated information that the PEGC-2 107 has the capability to anchor/act as the PEGC for the PIN during registration/join process. The information is recorded in the PIN dynamic information. In addition, the eighth method 1000 is performed in case the PEGC-1 105 which is currently assigned with the PEGC role is no longer available either due to crash/power drain or the duration to act as PEGC is expiring soon. The sequence of events (step 1 to step 9) of the eighth method 1000 is illustrated as follows:
In step 1 of method 1000, the PEMC 103, the PEGC-1 105, the PEGC-2 107, PINE-1 109, and PINE-2 111 are part of the same PIN 117. The PEGC-1 105 is currently acting as the PEGC of the PIN 117.
In step 2 of method 1000, the PEMC 103 detects that there is a need to replace the PEGC role which is currently assigned to the PEGC-1 105.
In step 3 of method 1000, the PEMC 103 signals or notifies or broadcasts all the PIN Elements currently active in the PIN that the PEGC role is being changed and requests if any of the PIN Elements can take the role of PEGC. This signal contains the PIN ID, the identifier of the PEGC-1 105, etc.
In step 4 of method 1000, the PEGC-2 107 on receiving the signal as in step-3 decides to take up the role of PEGC and sends the request to the PEMC 103 to indicate that the PEGC-2 107 can take the role of PEGC.
In step 5 of method 1000, the PEMC 103 checks the PIN information/PIN profile/PIN dynamic information to verify whether the PEGC-2 107 can be authorized to take the role of PEGC. In another embodiment, the PEMC 103 can query the PIN MS 101 whether the PEGC-2 107 can be authorized to take the role of PEGC.
In step 6 of method 1000, If the PEGC-2 107 is authorized to take the role of PEGC, the PEMC 103 sends a success response to the PEGC-2 107. If the PEGC-2 107 is not authorized to take the role of PEGC, the PEMC 103 sends a failure response and thereby waits for requests from other PIN Elements to take the role of PEGC and does not proceed with the next steps. On receiving the success response, the PEGC-2 107 needs to retrieve the PIN profile, PIN dynamic information, and active profile information of each active PIN Element either from the PIN MS 101 or from the PEMC 103. Alternatively, the information may be pushed to the PEGC-2 107 by the PEMC 103 or the PIN MS 101.
In step 7 of method 1000, the PEMC 103 notifies the PIN MS 101 that PEGC-1 105 is no longer acting as PEGC, and the PEGC-2 107 is assigned with the PEGC role of the PIN.
In step 8 of method 1000, the PIN MS 101 and the PEMC 103 update the PIN dynamic information with the details of changes.
In step 9 of method 1000, the PIN MS 101 or the PEMC 103 shares the updated the PIN dynamic information/the PIN profile with details of the PEGC-2 107. Alternatively, the PEGC-2 107 can fetch the updated PIN dynamic information from the PIN MS 101 or the PEMC 103.
In step 10 of method 1000, all the PIN Elements in the PIN are notified about the change in the PEGC and are provided with the details like PIN Element ID of the PEGC-2 107, PIN ID, and the reachability information of the PEGC-2 107. The PIN Elements can be notified in any of the following ways:
   The PIN MS 101 notifies the PEMC 103 about the change in the PEGC role and the PEMC 103, in turn, notifies all the PIN Elements (PINEs which were being served by the PEGC-1 105 earlier) in the PIN about the change in the PEGC role and the corresponding information like PINE ID of the new PEGC, reachability information of the new PEGC, duration of the role as PEGC, etc; or
   The PIN MS 101 notifies the PEMC 103 about the change in the PEMC role and also notifies all the PIN Elements (PINEs which were being served by the PEGC-1 105 earlier). The notification to the individual PIN Elements (without 3GPP access) is routed via the PEGC since the PIN MS 101 cannot reach the PIN Elements inside the PIN directly; or
   The new PINE taking the role of PEGC notifies all the PIN Elements (PINEs which were being served by the PEGC-1 105 earlier) that the PEGC-2 107 is taking the role of the PEGC and reachability information of the PEGC-2 107.

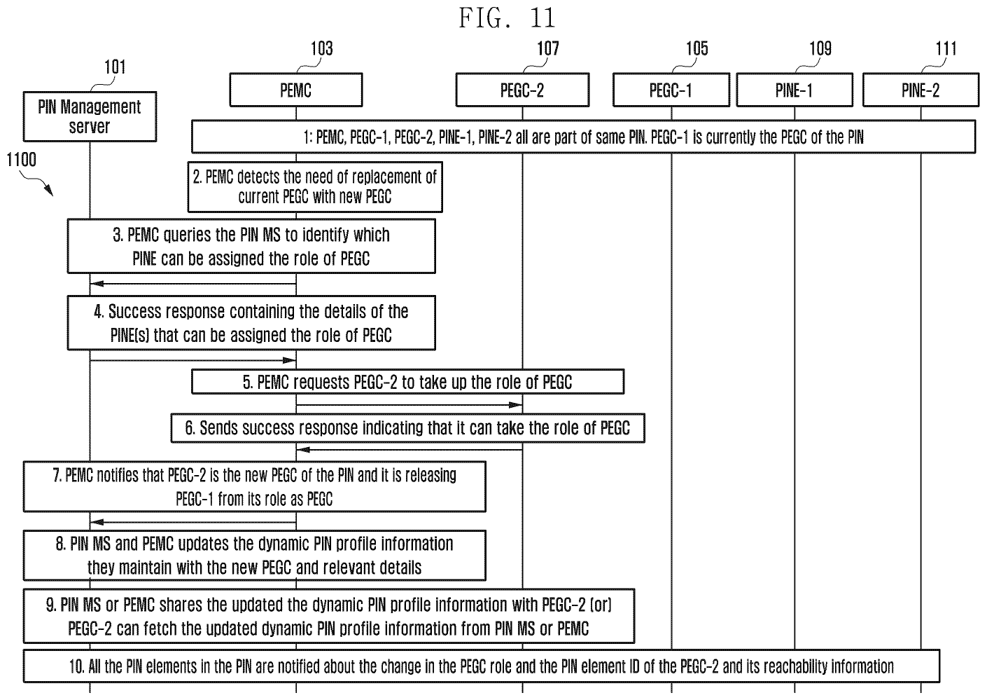

FIG. 11 illustrates a line diagram of a ninth method for the PEGC switchover or the PEGC replacement in context with PIN Elements of the PIN, in accordance with an embodiment of the present disclosure. FIG. 11, in particular, depicts the method 1100 including a sequence of events (step 1 to step 10) for the PEGC switchover or the PEGC replacement in the PIN 117. The method 1100 is performed in case where the PEGC-2 107 PIN Element has indicated information that it has the capability to anchor/act as the PEGC for the PIN during registration/join process. The information is recorded in the PIN dynamic information. In addition, the method 1100 is performed if the PEGC-1 105 which is currently assigned with the PEGC role is no longer available either due to crash/power drain or the duration to act as PEGC is expiring soon. The sequence of events (step 1 to step 10) of the ninth method 1100 is illustrated as follows:
In step 1 of method 1100, the PEMC 103, the PEGC-1 105, the PEGC-2 107, PINE-1 109, and PINE-2 111 are part of the same PIN 117. The PEGC-1 105 is currently acting as the PEGC of the PIN 117.
In step 2 of method 1100, the PEMC 103 detects that there is a need to replace the PEGC role which is currently assigned to the PEGC-1 105.
In step 3 of method 1100, the PEMC 103 requests/queries the PIN MS 101 to get the candidate PINEs that can be assigned the role of the PEGC.
In step 4 of method 1100, the PIN MS 101 sends the response containing the details of PINE(s) which can be assigned the role of the PEGC.
In step 5 of method 1100, if the response contains more than one candidate PINEs, the PEMC 103 can choose one of the PINE and sends a request to that PINE to check whether the PINE can take the role of PEGC. In this scenario, the PINE is PEGC-2 107.
In step 6 of method 1100, the PEGC-2 107 accepts to take the role of the PEGC and sends a success response to the PEMC 103.
In step 7 of method 1100, the PEMC 103 notifies the PIN MS 101 that the PEGC-1 105 is no more acting as the PEGC, and the PEGC-2 107 is assigned with the PEGC role of the PIN.
In step 8 of method 1100, the PIN MS 101 and the PEMC 103 update the PIN dynamic information with the details of the changes.
In step 9 of method 1100, the PIN MS 101 or the PEMC 103 shares the updated PIN dynamic information with the PEGC-2 107. Alternatively, the PEGC-2 107 may fetch the updated PIN dynamic information from the PIN MS 101 or the PEMC 103.
In step 10 of method 1100, all the PIN Elements in the PIN 117 are notified about the change in the PEGC and are provided with the details like the PIN Element ID of the PEGC-2 107, the PIN ID, and the reachability information of the PEGC-2 107. The PIN Elements may be notified in any of the following ways:
   The PIN MS 101 notifies the PEMC 103 about the change in the PEGC role and the PEMC 103, in turn, notifies all the PIN Elements (PINEs which were being served by the PEGC-1 105 earlier) in the PIN about the change in the PEGC role and the corresponding information like PINE ID of the PEGC-2 107, reachability information of the PEGC-2 107, duration of its role as PEGC, etc.; or
   The PIN MS 101 notifies the PEMC 103 about the change in the PEMC role and also notifies all the PIN Elements (PINEs which were being served by the PEGC-1 105 earlier). The notification to the individual PIN Elements (without the 3GPP access) is routed via the PEGC since the PIN MS 101 cannot reach the PIN Elements inside the PIN directly; or
   The new PINE taking the role of the PEGC notifies all the PIN Elements (PINEs which were being served by the PEGC-1 105 earlier) that the PEGC-2 107 is taking the role of PEGC and reachability information of the PEGC-2 107.

Referring now to the technical abilities and effectiveness of the method and system disclosed herein. The following technical advantages over the conventional and existing state of the art are provided such as playing an important role in replacing or switchover of the current PEGC which may go out of service soon. Thus, the present disclosure provides various methods of how the PEGC role may be changed within the PIN such that there is no service disruption, or no delay of the services rendered by the PIN Elements within the PIN. Also, the present disclosure provides various methods of automatic replacement of the PEGC either by the PIN MS or the PEMC which may overcome any requirement of manual intervention in case of PEGC replacement. Further, the proposed methods in the disclosure reduce dependency on any single component of the system, as either the PEMC or the PIN MS may be configured to perform the switchover or the replacement process.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The below table includes a list of abbreviations and acronyms that are being used in the description of the present disclosure:

| Abbreviation | Explanation |
|---|---|
| UE | User Equipment |
| 3GPP | 3^{rd} Generation Partnership Project |
| 5GC | 5G Core Network |
| D2D | Device to Device |
| FQDN | Fully Qualified Domain Name |
| PEGC | PIN Element with Gateway Capability |
| PEMC | PIN Element with Management Capability |
| PIN | Personal IoT Network |
| PINE | PIN Element |
| ProSe | Proximity Services |
| QoS | Quality of Service |
| UE | User Equipment |
| PIN MS | PIN Management Server |

1.-15. (canceled)

16. A method performed by a personal internet-of things (IoT) network (PIN) element with management capability (PEMC) in a wireless communication system, the method comprising:
detecting, based on an occurrence of one or more fault events, an unavailability of a first PIN element with gateway capability (PEGC) acting as a current PEGC of a PIN;
identifying, based on a PIN profile or PIN dynamic information, a second PEGC which is capable of taking up a role of a PEGC;
transmitting, to the second PEGC, a request to take the role of the PEGC;
receiving, from the second PEGC, a response for a success of a PEGC role takeover;
transmitting, to a PIN server, first information notifying that the second PEGC is a new PEGC of the PIN and the first PEGC is released from the role of the PEGC; and
transmitting, to a PIN element in the PIN, second information notifying a change in the role of the PEGC.

17. The method of claim 16, the method further comprising:
updating the PIN dynamic information with relevant details of the second PEGC; and
transmitting, to the second PEGC, the updated PIN dynamic information.

18. The method of claim 16,
wherein the second PEGC has indicated that the second PEGC has a capability to act as the PEGC during a registration process.

19. The method of claim 16,
wherein the second information includes a reachability information of the second PEGC.

20. The method of claim 16,
wherein the PIN dynamic information is available at the PEMC.

21. The method of claim 16,
wherein the one or more fault events correspond to at least one of a down of the first PEGC, a crash of the first PEGC, a power drain of the first PEGC, or a duration of the first PEGC to act as the PEGC is ending.

22. The method of claim 16,
wherein the PIN dynamic information is updated with relevant details of the second PEGC by the PIN server.

23. A personal internet-of-things (IoT) network (PIN) element with management capability (PEMC) in a wireless communication system, the PEMC comprising:
a memory; and
a processor configured to:
detect, based on an occurrence of one or more fault events, an unavailability of a first PIN element with gateway capability (PEGC) acting as a current PEGC of a PIN,
identify, based on a PIN profile or PIN dynamic information, a second PEGC which is capable of taking up a role of a PEGC,
transmit, to the second PEGC, a request to take the role of the PEGC,
receive, from the second PEGC, a response for a success of a PEGC role takeover,
transmit, to a PIN server, first information notifying that the second PEGC is a new PEGC of the PIN and the first PEGC is released from the role of the PEGC, and
transmit, to a PIN element in the PIN, second information notifying a change in the role of the PEGC.

24. The PEMC of claim 23, wherein the processor is further configured to:
update the PIN dynamic information with relevant details of the second PEGC, and
transmit, to the second PEGC, the updated PIN dynamic information.

25. The PEMC of claim 23,
wherein the second PEGC has indicated that the second PEGC has a capability to act as the PEGC during a registration process.

26. The PEMC of claim 23,
wherein the second information includes a reachability information of the second PEGC.

27. The PEMC of claim 23,
wherein the PIN dynamic information is available at the PEMC.

28. The PEMC of claim 23,
wherein the one or more fault events correspond to at least one of a down of the first PEGC, a crash of the first PEGC, a power drain of the first PEGC, or a duration of the first PEGC to act as the PEGC is ending.

29. The PEMC of claim 23,
wherein the PIN dynamic information is updated with relevant details of the second PEGC by the PIN server.

30. A method performed by a second personal internet-of-things (IoT) network (PIN) element with gateway capability (PEGC) in a wireless communication system, the method comprising:
receiving, from a PIN element with management capability (PEMC) which detects an unavailability of a first PEGC acting as a current PEGC of a PIN based on an occurrence of one or more fault events, a request to take a role of a PEGC, in case that the second PEGC is capable of taking up a role of PEGC based on a PIN profile or PIN dynamic information;
transmitting, to the PEMC, a response for a success of a PEGC role takeover; and
receiving, from the PEMC, the PIN dynamic information updated with relevant details of the second PEGC.

31. The method of claim 30,
wherein the second PEGC has indicated that the second PEGC has a capability to act as the PEGC during a registration process, and
wherein the PIN dynamic information is available at the PEMC.

32. The method of claim 30,
wherein the one or more fault events corresponds to at least one of a down of the first PEGC, a crash of the first PEGC, a power drain of the first PEGC, or a duration of the first PEGC to act as the PEGC is ending.

33. A second personal internet-of-things (IoT) network (PIN) element with gateway capability (PEGC) in a wireless communication system, the second PEGC comprising:
a memory; and
a processor configured to:
receive, from a PIN element with management capability (PEMC) which detects an unavailability of a first PEGC acting as a current PEGC of a PIN based on an occurrence of one or more fault events, a request to take a role of a PEGC, in case that the second PEGC is capable of taking up a role of PEGC based on a PIN profile or PIN dynamic information,
transmit, to the PEMC, a response for a success of a PEGC role takeover, and
receive, from the PEMC, the PIN dynamic information updated with relevant details of the second PEGC.

34. The second PEGC of claim 33,
wherein the second PEGC has indicated that the second PEGC has a capability to act as the PEGC during a registration process, and
wherein the PIN dynamic information is available at the PEMC.

35. The second PEGC of claim 33,
wherein the one or more fault events corresponds to at least one of a down of the first PEGC, a crash of the first PEGC, a power drain of the first PEGC, or a duration of the first PEGC to act as the PEGC is ending.
